(19) United States
(12) Patent Application Publication
(10) Pub. No.: US 2026/0163946 A1
(43) Pub. Date: Jun. 11, 2026

(54) METHOD AND APPARATUS FOR MANAGING VEHICLE COMPONENTS

(71) Applicants: HYUNDAI MOTOR COMPANY, Seoul (KR); KIA CORPORATION, Seoul (KR)

(72) Inventors: Dong Ok Kim, Hwaseong-si (KR); Singu Kim, Hwaseong-si (KR); Jae Won Chang, Hwaseong-si (KR); Young Jong Lee, Hwaseong-si (KR)

(73) Assignees: HYUNDAI MOTOR COMPANY, Seoul (KR); KIA CORPORATION, Seoul (KR)

(21) Appl. No.: 19/387,151

(22) Filed: Nov. 12, 2025

(30) Foreign Application Priority Data
Dec. 6, 2024 (KR) 10-2024-0180865

(51) Int. Cl. H04L 67/12; G07C 5/00

(52) U.S. Cl. CPC H04L 67/12; G07C 5/00

(57) ABSTRACT

A method for managing a plurality of vehicle components installed at different positions, in a vehicle in which a plurality of positioning anchors are provided, includes detecting installation positions of the plurality of vehicle components using the plurality of positioning anchors. The method also includes receiving an attribute data of the plurality of vehicle components through the plurality of positioning anchors. The method additionally includes registering information on a new vehicle component, the information including at least one of whether the new vehicle component has been installed, an installation position of the new vehicle component, or one or more attributes of the new vehicle component, obtained from the attribute data, in a vehicle component database. The method additionally includes providing a vehicle component management application service based on information on the vehicle component registered in the vehicle component database.

### CROSS-REFERENCE TO RELATED APPLICATION

This application claims priority to and the benefit of Korean Patent Application No. 10-2024-0180865, filed on Dec. 6, 2024, the entire contents of which are hereby incorporated herein by reference.

### BACKGROUND

### (a) Technical Field

The present disclosure relates to a method and apparatus for managing vehicle components.

### (b) Description of the Related Art

The statements in this section merely provide background information related to the present disclosure and may not constitute prior art.

Modern vehicles often feature multiple versions of the same type of component, each of which may need to perform different functional roles depending on its position. For example, components such as sensors and modules may process data or perform control differently depending on their installation position within the vehicle, and it is important to properly identify and manage them. However, currently, when the position of a component is changed or the component is replaced, it must be checked and adjusted manually by a person, which is time-consuming and causes inconvenience to the user.

### SUMMARY

Embodiments of the present disclosure provide a method and apparatus for managing vehicle components, that provide settings and management for a vehicle component having position dependency.

According to an embodiment, a method is provided for managing a plurality of vehicle components installed at different positions in a vehicle in which a plurality of positioning anchors are provided. The method includes detecting, by a processor, installation positions of the plurality of vehicle components using the plurality of positioning anchors. The method also includes receiving, by the processor, attribute data of the plurality of vehicle components through the plurality of positioning anchors. The method additionally includes registering, by the processor, information on a new vehicle component, the information including at least one of whether the new vehicle component has been installed, an installation position of the new vehicle component, or one or more attributes of the new vehicle component, obtained from the attribute data, in a vehicle component database. The method further includes providing, by the processor, a vehicle component management application service based on information on the vehicle component registered in the vehicle component database.

The attribute data may include at least one of a Bluetooth MAC address, a name, production information or position information on the installation position, for the new vehicle component.

The positioning anchors may include positioning anchors supporting ultra-wideband (UWB) and Bluetooth Low Energy (BLE).

The vehicle components may include at least one of a tire, a camera, an ultrasonic wave sensor, and a zone controller.

The method may further include transmitting, by the processor, a predetermined value to the new vehicle component registered in the vehicle component database using a protocol enabling communication with the new vehicle component.

The method may further include updating, by the processor, the installation positions of the plurality of vehicle components by using the plurality of positioning anchors, according to a preset cycle.

The method may further include updating, by the processor, attribute data of the plurality of vehicle components through the plurality of positioning anchors, according to a preset cycle.

The method may further include providing, by the processor, the attribute data to another controller related to the vehicle.

The method may further include: determining, by the processor, whether identification information of the new vehicle component that is newly detected is the same as identification information of a vehicle component that was previously detected in relation to a same installation position; and determining, by the processor, that a replacement of the vehicle component has occurred, based on determining that the identification information of the new vehicle component that is newly detected is not to the same as the identification information of the vehicle component that was previously detected in relation to the same installation position.

Providing the vehicle component management application service may include transmitting the information on the vehicle component registered in the vehicle component database to a user terminal in which an application for managing the vehicle is executed, and providing an application service including providing status information and providing management function with respect to the vehicle component through the user terminal.

According to another embodiment, an apparatus is provided for managing a plurality of vehicle components installed at different positions in a vehicle in which a plurality of positioning anchors are provided. The apparatus includes one or more non-transitory computer-readable media storing computer-readable instructions. The apparatus also includes one or more processors configured to execute the computer-readable instructions to: detect installation positions of the plurality of vehicle components using the plurality of positioning anchors; receive attribute data of the plurality of vehicle components through the plurality of positioning anchors; register information on a new vehicle component, the information including at least one of whether the new vehicle component has been installed or an installation position of the new vehicle component, or one or more attributes of the new vehicle component, obtained from the attribute data, in a vehicle component database; and provide a vehicle component management application service based on information on the vehicle component registered in the vehicle component database.

The attribute data may include at least one of a Bluetooth MAC address, a name, production information, or position information on the installation position, for the new vehicle component.

The positioning anchors may include positioning anchors supporting ultra-wideband (UWB) and Bluetooth Low Energy (BLE).

The vehicle components may include at least one of a tire, a camera, an ultrasonic wave sensor, and a zone controller.

The one or more processors may further execute the computer-readable instructions to transmit a predetermined value to the new vehicle component registered in the vehicle component database using a protocol enabling communication with the vehicle component.

The one or more processors may further execute the computer-readable instructions to update the installation positions of the plurality of vehicle components by using the plurality of positioning anchors, according to a preset cycle.

The one or more processors may further execute the computer-readable instructions to update attribute data of the plurality of vehicle components through the plurality of positioning anchors according to a preset cycle.

The one or more processors may further execute the computer-readable instructions to provide the attribute data to another controller related to the vehicle.

The one or more processors may further execute the computer-readable instructions to determine whether identification information of the new vehicle component that is newly detected is to the same as identification information of a vehicle component that was previously detected in relation to a same installation position, and determine that a replacement of the vehicle component has occurred, based on determining that the identification information of the new vehicle component that is newly detected is not the same as the identification information of the vehicle component that was previously detected in relation to the same installation position.

According to still another embodiment, one or more non-transitory computer-readable media storing computer-readable instructions are provided. The computer-executable instructions, when executed by one or more processors, cause the one or more processors to: detect installation positions of a plurality of vehicle components by using a plurality of positioning anchors; receive attribute data of the plurality of vehicle components through the plurality of positioning anchors; register information on a new vehicle component, the information including at least one of whether the new vehicle component has been installed an installation position of the new vehicle component, or one or more attributes of the new vehicle component, obtained from the attribute data, in a vehicle component database; and provide a vehicle component management application service based on information on the vehicle component registered in the vehicle component database.

### BRIEF DESCRIPTION OF THE DRAWINGS

FIG. 1 is a drawing for explaining an apparatus for managing vehicle components according to an embodiment.

FIG. 2 is a drawing for explaining a method for managing vehicle components according to an embodiment.

FIGS. 3-7 are drawings for explaining examples of vehicle components having position dependency according to embodiments.

FIG. 8 is a drawing for explaining a method for managing vehicle components according to an embodiment.

FIG. 9 is a drawing for explaining a computing device according to an embodiment.

### DETAILED DESCRIPTION

Embodiments of the present disclosure are described in more detail hereinafter with reference to the accompanying drawings, in which embodiments of the disclosure are shown. As those having ordinary skill in the art should realize, the described embodiments may be modified in various different ways, all without departing from the spirit or scope of the present disclosure. Accordingly, the drawings and description are should be regarded as illustrative in nature and not restrictive. Like reference numerals designate like elements throughout the specification.

Throughout the specification and claims, when a part “includes” a certain element, it means that other elements may be further included, rather than excluding other elements, unless otherwise stated. Terms including ordinal numbers such as first, second, and the like may be used to describe various constituent elements. These terms are used to differentiate one constituent element from other constituent elements. These terms should not be interpreted as limiting the constituent elements.

In addition, terms such as “ . . . part,” “ . . . portion,” “ . . . er/or,” or “module” in the present specification may mean a unit that may process at least one function or operation described in this specification, and this may be implemented by hardware, software, or a combination thereof. Additionally, at least some of the configurations or functions of managing vehicle components and apparatus for managing vehicle components according to the embodiments described below may be implemented as a program or software, and the program or software may be stored in a computer-readable medium.

When a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

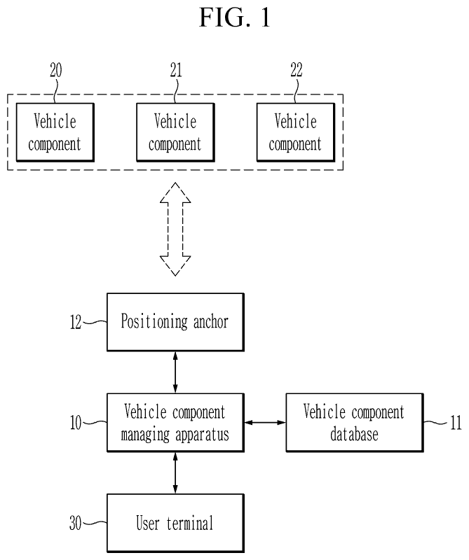

FIG. 1 is a drawing for explaining an apparatus for managing vehicle components according to an embodiment.

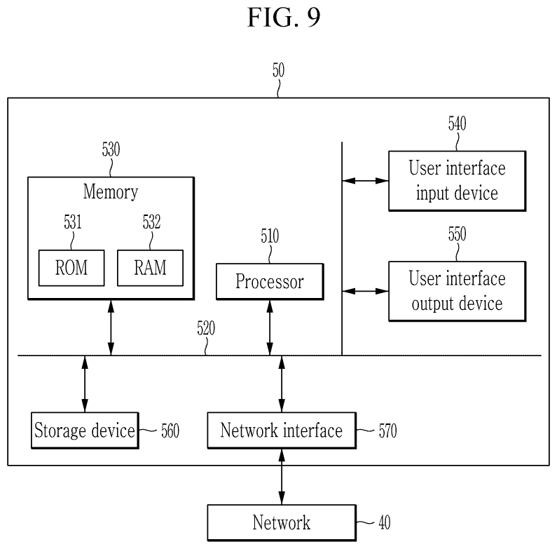

Referring to FIG. 1, an apparatus 10 for managing vehicle components according to an embodiment may be implemented as a computing device including a processor and memory. For example, the apparatus 10 for managing vehicle components may be implemented as a computing device 50, as described later in connection with FIG. 9. The computing device 50 may be implemented in a vehicle 1, for example, implemented as a controller mounted in the vehicle 1. In this case, the processor may correspond to a processors 510 of the computing device 50, and the memory may correspond to a memory 520 of the computing device 50. In some embodiments, the apparatus 10 for managing vehicle components may include one or more non-transitory computer-readable media storing computer-readable instructions and one or more processors configured to perform operations by executing the computer-readable instructions. The operation may include configurations, functions, steps, and/or the like described in this specification with respect to a method and apparatus for managing vehicle components according to embodiments.

The apparatus 10 for managing vehicle components may be implemented within the vehicle 1. The apparatus 10 for managing vehicle components may exchange data with sensors, controllers, and/or the like, as well as a positioning anchor 12 implemented together within, or otherwise provided in, the vehicle 1, via an internal network. In some embodiments, the internal network may include a controller area network (CAN), a local interconnect network (LIN), an automotive ethernet, or the like.

In a vehicle in which a plurality of positioning anchors 12 are mounted (or otherwise provided), the apparatus 10 for managing vehicle components may manage a plurality of vehicle components 20, 21, and 22 installed at different positions in the vehicle. The positioning anchor 12 may include the positioning anchor supporting ultra-wideband (UWB) and Bluetooth Low Energy (BLE) (also referred to as ‘UWB/BLE anchor’). In an embodiment, the positioning anchor 12 may be designed to perform all functions of a UWB anchor and/or a BLE anchor.

The UWB anchor may support high-precision indoor positioning and data communications using very short pulse signals based on ultra-wideband technology. For example, the UWB anchor may calculate position by using time of flight (TOF) or time difference of arrival (TDOA) methods, providing accuracy within a few centimeters. Additionally, the UWB anchor may be resistant to signal interference and may support high data transmission speeds by using a wide frequency band of 500 MHz or more.

The BLE anchor may operate based on low-power Bluetooth technology and may be primarily used for indoor positioning and simple data communication. For example, the BLE anchor may estimate position based on a signal strength (i.e., Received Signal Strength Indicator; RSSI). Accordingly, accuracy of a BLE anchor may be lower than that of UWB (on the order of several meters), but high energy efficiency of the BLE anchor may allow for long-term use in battery-powered devices.

In some embodiments, the vehicle components may include, for example, at least one of a tire, a camera, an ultrasonic wave sensor, or a zone controller. In an embodiment, the zone controller may mean an electronic control unit (ECU) that divides the vehicle into specific zones and independently controls and manages the functions and devices of each zone.

The apparatus 10 for managing vehicle components may detect installation positions of the plurality of vehicle components 20, 21, and 22 by using the plurality of positioning anchors 12. For example, when the vehicle component is a tire, the apparatus 10 for managing vehicle components may detect the installation position of each of a plurality of tires by using the plurality of positioning anchors 12. The position of the tire may be detected by, for example, implementing the communication scheme of a tire pressure sensor configured to detect a pressure of each tire as a Bluetooth communication scheme, and causing the tire pressure sensor to transmit component information regarding a tire to the positioning anchor 12. A position data created to identify a position within the vehicle according to a predetermined protocol may be included in the component information. In the case of the camera, the ultrasonic wave sensor, and the zone controller, the position of each device can be detected in a way in which each device transmits the component information including its position information to the positioning anchor 12 through Bluetooth communication.

The apparatus 10 for managing vehicle components may receive the component information, including attribute data of with the plurality of vehicle components 20, 21, and 22, through the plurality of positioning anchors 12. In some embodiments, the attribute data may include at least one among a Bluetooth media access control (MAC) address, a name, production information, position information on the installation position, and/or other unique information for the vehicle component. For example, when the vehicle component is a tire, the attribute data may include a Bluetooth MAC address for the tire pressure sensor corresponding to the tire, a name for identifying the corresponding tire, production information of the corresponding tire, an installation position within the vehicle of the corresponding tire, and/or the like. In the case of the camera, the ultrasonic wave sensor, and the zone controller, the attribute data may include a Bluetooth MAC address for the device, a name for identifying the device, production information of the device, an installation position within the vehicle of the device, and/or the like.

The apparatus 10 for managing vehicle components may register information on a new vehicle component in a vehicle component database 11, based on the attribute data of the plurality of vehicle components 20, 21, and 22. In an embodiment, the information on the new vehicle component may include at least one of whether the new vehicle component has been installed (e.g., whether the corresponding vehicle component is newly installed in the vehicle), the installation position of the new vehicle component within the vehicle, and/or other attributes. For example, when the vehicle component is a tire, the information on the new vehicle component may include at least one of whether the new vehicle component has been installed, i.e., whether the corresponding tire is newly installed in the vehicle, the installation position such as front-left side, front-right side, rear-left side, and rear right side, and/or other attributes.

In some embodiments, the apparatus 10 for managing vehicle components may transmit a predetermined value to the vehicle component registered in the vehicle component database 11 using a protocol enabling communication with the vehicle component.

In some embodiments, the apparatus 10 for managing vehicle components may update the installation positions of the plurality of vehicle components 20, 21, and 22 by using the plurality of positioning anchors 12, according to a preset cycle.

In some embodiments, the apparatus 10 for managing vehicle components may update the attribute data of the plurality of vehicle components 20, 21, and 22 through the plurality of positioning anchors 12.

In some embodiments, the apparatus 10 for managing vehicle components may provide the attribute data to another controller related to or associated with the vehicle.

In some embodiments, the apparatus 10 for managing vehicle components may determine whether identification information of the vehicle component that is newly detected is the same as (e.g., identical to) identification information of the vehicle component that was previously detected regarding the same installation position, and when it is determined that the identification information of the vehicle component that is newly detected is the same as (e.g., not identical to) the identification information of the vehicle component that was previously detected regarding the same installation position, may determine or recognize that a replacement of the vehicle component has occurred.

The apparatus 10 for managing vehicle components may provide a vehicle component management application service based on information on the vehicle component registered in the vehicle component database 11. In an embodiment, the apparatus 10 for managing vehicle components may transmit the information on the vehicle component registered in the vehicle component database 11 to a user terminal 30, for example, a smart phone, in which an application for managing the vehicle is executed, and may provide an application service including providing status information and providing management function with respect to the vehicle component through the user terminal 30.

As such, settings and management of the vehicle component having position dependency such as the tire, the camera, the ultrasonic wave sensor, the zone controller can be automated, so that the same component having position dependency can be effectively managed, and the position can be identified and controlled in an automated method.

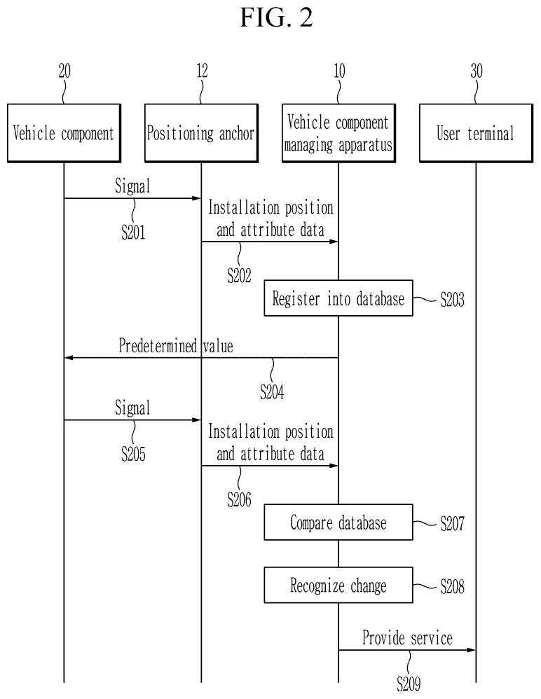

FIG. 2 is a drawing for explaining a method for managing vehicle components according to an embodiment.

Referring to FIG. 2, a method for managing vehicle components according to an embodiment may include a step or operation S201 of receiving, by the positioning anchor 12, a signal from the vehicle component 20, a step or operation S202 of receiving, by the apparatus 10 for managing vehicle components, the installation position and the attribute data from the positioning anchor 12, and a step or operation S203 of registering information received by the apparatus 10 for managing vehicle components to the vehicle component database 11.

In an embodiment, the method may further include transmitting, by the apparatus 10 for managing vehicle components, a predetermined value to the vehicle component 20 registered in the vehicle component database 11.

In an embodiment, the method may further perform a step or operation S205 of receiving, by the positioning anchor 12, a signal from the vehicle component 20, a step or operation S206 of receiving, by the apparatus 10 for managing vehicle components, the installation position and the attribute data from the positioning anchor 12, a step or operation S207 of comparing the information received by the apparatus 10 for managing vehicle components with information registered in the vehicle component database 11, a step or operation S208 of recognizing, by the apparatus 10 for managing vehicle components, a change of the vehicle component 20, and a step or operation S209 of providing, by the apparatus 10 for managing vehicle components, a service to the user terminal 30 based on the change.

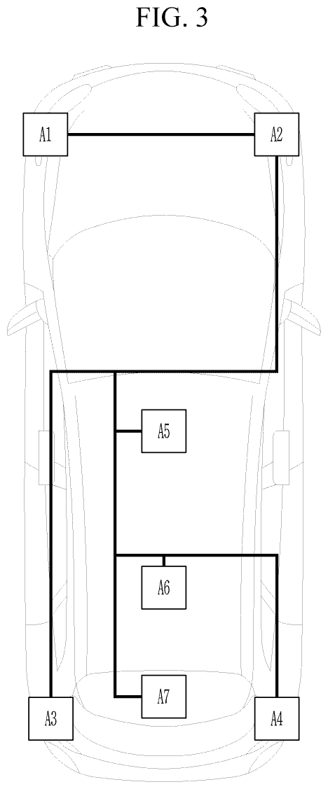

FIGS. 3-7 are drawings for explaining examples of the vehicle component having position dependency, according to embodiments.

Referring to FIG. 3, a plurality of positioning anchors A1, A2, A3, A4, A5, A6, and A7 may be mounted or otherwise provided in the vehicle. The plurality of positioning anchors A1, A2, A3, A4, A5, A6, and A7 may be implemented as the UWB/the BLE anchor. The positioning anchors A1 and A2 may be provided at the front of the vehicle, the positioning anchors A3 and A4 may be provided at the rear of the vehicle, and the positioning anchors A5, A6, and A7 may be provided at the center of the vehicle.

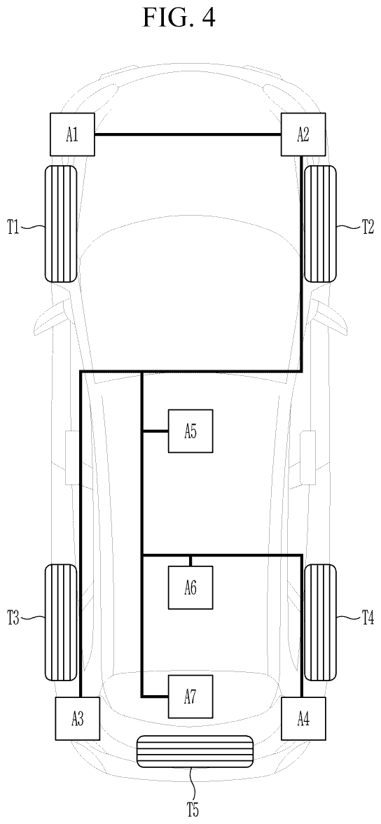

Referring to FIG. 4, tires T1, T2, T3, T4, and T5 may be mounted or otherwise provided in the vehicle, as the vehicle components having position dependency. Information on the tires T1, T2, T3, T4, and T5 may be transmitted to the apparatus 10 through communication between other devices operating in relation to the tires T1, T2, T3, T4, and T5 and the plurality of positioning anchors A1, A2, A3, A4, A5, A6, and A7.

The information on the tire T1, for example, data including a Bluetooth MAC address for the tire pressure sensor corresponding to the tire T1, a name for identifying the tire T1, production information of the tire T1, and/or the installation position of the tire T1 within the vehicle may be transmitted to the apparatus 10 through communication between the tire pressure sensor and the positioning anchor A1 operating in relation to the tire T1. In the same way, the information on the tire T2, for example, data including a Bluetooth MAC address for the tire pressure sensor corresponding to the tire T2, a name for identifying the tire T2, production information of the tire T2, and/or the installation position of the tire T2 within the vehicle may be transmitted to the apparatus 10 through communication between another tire pressure sensor and a positioning anchor A2 operating in relation to the tire T2. Similarly, the information on the tire T3 may be transmitted through the positioning anchor A3, the information on the tire T4 may be transmitted through a positioning anchor A4, and the information on the tire T5 may be transmitted through a positioning anchor A7, to the apparatus 10.

The apparatus 10 may determine whether identification information of a tire that is newly detected is identical to identification information of the tire that was previously detected regarding the same installation position, and when it is determined that the identification information of the tire that is newly detected is not identical to the identification information of the tire that was previously detected regarding the same installation position, may recognize that replacement of the tire has occurred, and may provide the application service including the providing tire status information and the providing management function through the user terminal 30.

For example, as an implementation example, a tire mounting position may be managed based on the Bluetooth MAC address. Specifically, data related to mounting position of the tire can be recorded and managed by being linked with an in-vehicle infotainment (IVI) of the vehicle, a server, and a user's mobile phone. In an initial setting step, a MAC address of each tire pressure sensor (TPS) may be allocated to each tire. For example, MAC_a may be set for tire number 8, MAC_b may be set for tire number 9, MAC_c may be set for tire number 12, MAC_d may be set for tire number 13, and MAC_e may be set for tire number 3.

When the tire position is changed, it may be detected through the UWB anchor and may be notified to the IVI. The IVI may transmit the corresponding information to the server, and (e.g., simultaneously) may notify the change of position to the user's smart phone App. The Bluetooth MAC address, which is a unique value, may be matched with the production date of the tire, so that the user can check the production information of the tire. In the BLE connection setting process, in order to comply with the vehicle cyber security, an encrypted authentication key may be exchanged, and such connection may be set through a connected App.

The existing TPMS may have several problems. First, the coin-type batteries used in the sensors have a lifespan of only 5 to 10 years, and when the batteries are depleted, a low-inflation warning message is displayed, requiring drivers to pay to resolve the issue. Second, when tire positions are exchanged, the sensor warning notifications often do not match the actual tire positions, which may require re-recognition, resulting in additional costs. Third, since the existing tire pressure monitoring system (TPMS) uses RF communication scheme (433.92 MHz to 447 MHz), the reception rate may be reduced due to communication interference with non-genuine electrical components (e.g. navigation, black box, etc.).

The BLE-based TPMS system, according to embodiments, may improve these problems. By utilizing BLE communication, the position can be (e.g., automatically) determined or recognized when the tire position is changed, and the function to manually or automatically input the sensor ID by communicating with the TPMS BLE module of each wheel may be provided. Additionally, BLE uses a frequency band (e.g., 2.4 GHz) different from that of RF, so it can minimize communication interference and can diagnose sensor faults or register sensor IDs. Furthermore, the BLE system may monitor a TPMS battery state by a logic to detect a problem in advance, and to provide a notification to the user, thereby preventing sudden tire failure. That is, the BLE-based TPMS system may increase the efficiency of tire position management, and the problems of the existing TPMS can be effectively solved. This can increase the convenience of vehicle maintenance and help users operate their vehicles more safely and efficiently.

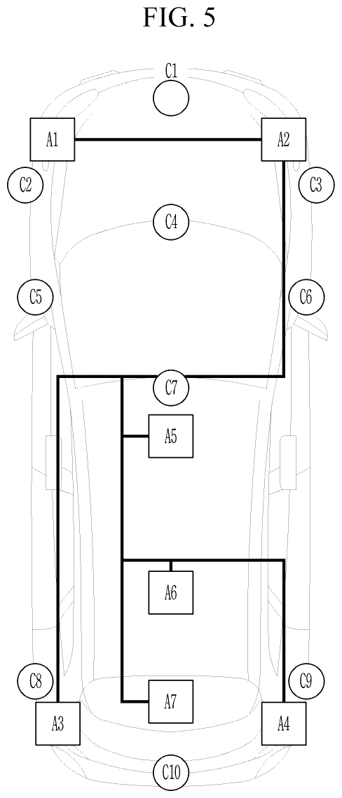

Referring to FIG. 5, cameras C1, C2, C3, C4, C5, C6, C7, C8, C9, and C10 may be mounted or otherwise provided in the vehicle, as the vehicle components having position dependency. Information on the cameras C1, C2, C3, C4, C5, C6, C7, C8, C9, and C10 may be transmitted to the apparatus 10 through communication between other devices operating in relation to the cameras C1, C2, C3, C4, C5, C6, C7, C8, C9, and C10 and the plurality of positioning anchors A1, A2, A3, A4, A5, A6, and A7.

The information on the camera C1, for example, data including the Bluetooth MAC address for the camera C1, a name for identifying the camera C1, production information of the camera C1, and/or the installation position of the camera C1 within the vehicle may be transmitted to the apparatus 10 through communication between the camera C1 and the positioning anchors A1 and A2. In the same way, the information on the camera C2, for example, data including the Bluetooth MAC address for the camera C2, a name for identifying the camera C2, production information of the camera C2, and/or the installation position of the camera C2 within the vehicle may be transmitted to the apparatus 10 through communication between the camera C2 and the positioning anchor A1. Similarly, the information on the remaining cameras C3, C4, C5, C6, C7, C8, C9, and C10 may be transmitted to the apparatus 10 through the appropriately selected positioning anchor(s).

The apparatus 10 may determine whether identification information of the camera that is newly detected is identical to identification information of the camera that was previously detected in relation to the same installation position, and when it is determined that the identification information of the camera that is newly detected is not identical to the identification information of the camera that was previously detected regarding the same installation position, may recognize that a replacement of the camera has occurred, and may provide an application service including providing camera status information and providing the management function through the user terminal 30.

For example, as an implementation example, a function for linking and inspecting the in-vehicle camera may be provided. Users can check the status of the vehicles and diagnose faults through an App. For example, in the existing system, if the in-vehicle camera fails, the customer is only notified with vague phrases, and in order to check the actual failure, the vehicle must be brought to a repair center and scanned. For example, when a front camera module is in failure, the cluster would only display the massage, “Check the forward collision avoidance assist system”, but would not provide accurate failure information. In the improved system, according to embodiments, each camera communicates through a BLE module, allowing the position of a faulty camera and specific details of the fault to be provided to a connected App. For example, it may provide clear fault information such as “FR_CMR front camera faulty”.

Additionally, existing Apps could only provide video during parking by linking surrounding video or built-in cam. However, in the improved system, according to embodiments, specialized functions for each camera position may be provided. For example, the front camera may provide video not only when parked, but also while driving or at low speeds (e.g., under 5 km/h) with the engine running, which can meet various customer needs. These improvements may improve the user experience and enable solving the camera-related issues more effectively, in various embodiments.

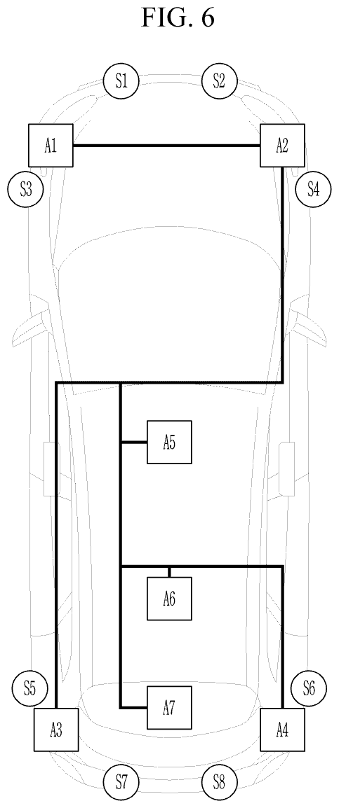

Referring to FIG. 6, ultrasonic wave sensors S1, S2, S3, S4, S5, S6, S7, S8 may be mounted or otherwise provided in the vehicle, as the vehicle components having position dependency. Information on the ultrasonic wave sensors S1, S2, S3, S4, S5, S6, S7, S8 may be transmitted to the apparatus 10 through communication between other devices operating in relation to the ultrasonic wave sensors S1, S2, S3, S4, S5, S6, S7, S8 and the plurality of positioning anchors A1, A2, A3, A4, A5, A6, and A7.

The information on the ultrasonic wave sensor S1, for example, data including the Bluetooth MAC address for the ultrasonic wave sensor S1, a name for identifying the ultrasonic wave sensor S1, production information of the ultrasonic wave sensor S1, and/or the installation position of the ultrasonic wave sensor S1 within the vehicle may be transmitted to the apparatus 10 through communication between the ultrasonic wave sensor S1 and the positioning anchor A1. In the same way, the information on the ultrasonic wave sensor S2, for example, data including the Bluetooth MAC address for the ultrasonic wave sensor S2, a name for identifying the ultrasonic wave sensor S2, production information of the ultrasonic wave sensor S2, and/the installation position of the ultrasonic wave sensor S2 within the vehicle may be transmitted to the apparatus 10 through communication between the ultrasonic wave sensor S2 and the positioning anchor A2. Similarly, the information on the remaining ultrasonic wave sensors S3, S4, S5, S6, S7, and S8 may be transmitted to the apparatus 10 through the appropriately selected positioning anchor(s).

The apparatus 10 may determine whether identification information of the ultrasonic wave sensor that is newly detected is identical to identification information of the ultrasonic wave sensor that was previously detected regarding the same installation position, and when it is determined that the identification information of the ultrasonic wave sensor that is newly detected is not identical to the identification information of the ultrasonic wave sensor that was previously detected regarding the same installation position, may recognize that a replacement of the ultrasonic wave sensor has occurred, and may provide an application service including providing ultrasonic wave sensor status information and providing the management function through the user terminal 30.

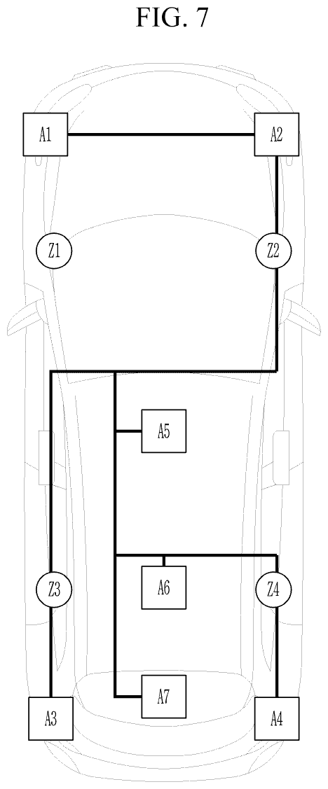

Referring to FIG. 7, zone controllers Z1, Z2, Z3, and Z4 may be mounted or otherwise provided in the vehicle, as the vehicle components having position dependency. Information on the zone controllers Z1, Z2, Z3, and Z4 may be transmitted to the apparatus 10 through communication between other devices operating in relation to the zone controllers Z1, Z2, Z3, and Z4 and the plurality of positioning anchors A1, A2, A3, A4, A5, A6, and A7.

The information on the zone controller Z1, for example, data including the Bluetooth MAC address for the zone controller Z1, a name for identifying the zone controller Z1, production information of the zone controller Z1, and/or the installation position of the zone controller Z1 within the vehicle may be transmitted to the apparatus 10 through communication between the zone controller Z1 and the positioning anchors A1 and A2. In the same way, the information on the zone controller Z2, for example, data including the Bluetooth MAC address for the zone controller Z2, a name for identifying the zone controller Z2, production information of the zone controller Z2, and/or the installation position of the zone controller Z2 within the vehicle may be transmitted to the apparatus 10 through communication between the zone controller Z2 and the positioning anchor A1. Similarly, the information on the remaining zone controllers Z3 and Z4 may be transmitted to the apparatus 10 for managing vehicle components through the appropriately selected positioning anchor(s).

The apparatus 10 may determine whether identification information of the zone controller that is newly detected is identical to identification information of the zone controller that was previously detected regarding the same installation position, and when it is determined that the identification information of the zone controller that is newly detected is not identical to the identification information of the zone controller that was previously detected regarding the same installation position, may recognize that a replacement of the zone controller has occurred, and may provide an application service including providing zone controller status information and providing the management function through the user terminal 30.

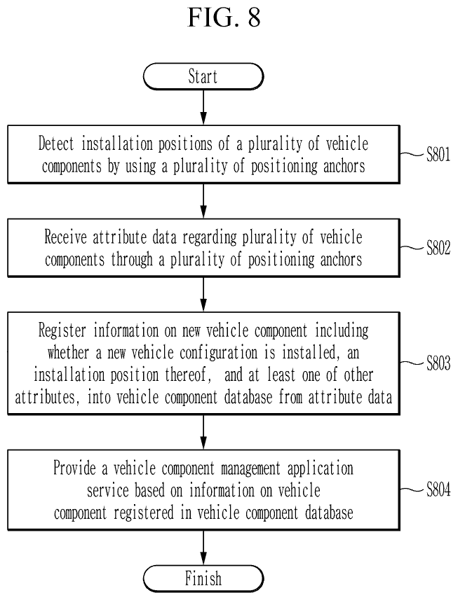

FIG. 8 is a drawing for explaining a method for managing vehicle components according to an embodiment.

Referring to FIG. 8, a method for managing vehicle components according to an embodiment may include a step or operation S801 of detecting the installation positions of the plurality of vehicle components using the plurality of positioning anchors, a step or operation S802 of receiving attribute data of the plurality of vehicle components through the plurality of positioning anchors, a step or operation S803 of registering information on a new vehicle component, the information including at least one of whether the new vehicle component has been installed, an installation position of the new vehicle component, and one or more attributes of the new vehicle component, obtained from the attribute data, in the vehicle component database, and a step or operation S804 of providing the vehicle component management application service based on the information on the vehicle component registered in the vehicle component database.

For further details of the above methods, reference may be made to the embodiments described herein, so that duplicative description is omitted herein.

FIG. 9 is a drawing for explaining a computing device according to an embodiment.

Referring now to FIG. 9, a method and apparatus for managing vehicle components according to the embodiments may be implemented by using a computing device 50. The computing device 50 may be implemented as various types of electronic devices, servers or similar devices, and its function may be implemented through a combination of software and hardware.

The computing device 50 may include at least one of a processor 510, a memory 530, a user interface input device 540, a user interface output device 550 and a storage device 560 that communicate with each other through a bus 520. The computing device 50 may include a network interface 570 electrically connected to a network 40. The network interface 570 may send or receive signals to and from other entities through the network 40.

The processor 510 may be implemented as various types of calculation devices, such as a microcontroller unit (MCU), an application processor (AP), a central processing unit (CPU), a graphic processing unit (GPU), a neural processing unit (NPU), a quantum processing unit (QPU), etc. The processor 510 is also a semiconductor device that executes instructions stored in the memory 530 or the storage device 560 and may play a key role in the system. Program codes and data stored in the memory 530 or the storage device 560 instruct the processor 510 to perform specific tasks, thereby enabling the overall operation of the system. In this way, the processor 510 may be configured to implement the various functions and methods described above with reference to FIGS. 1-8.

The memory 530 and storage device 560 may include various forms of volatile or non-volatile storage medium for storing and accessing data of the system. For example, the memory 530 may include a read-only memory (ROM) 531 and a random-access memory (RAM) 532. In some embodiments, the memory 530 may be built into the processor 510, in which case data transmission speeds between the memory 530 and the processor 510 may be very fast. In some other embodiments, the memory 530 may be disposed externally to the processor 510, in which case the memory 530 may be connected to the processor 510 through various data buses or interfaces. This connection may be made through a variety of known means—for example, a peripheral component interconnect express (PCIe) interface for high-speed data transmission or a memory controller.

In some embodiments, at least some components or functions of a method and apparatus for managing vehicle components according to the embodiments may be implemented as the program or software executed by the computing device 50, and the program or software may be stored in a computer-readable recording or storage medium. In detail, the computer-readable recording or storage medium according to an embodiment may have a program recorded for executing steps included in the implementation of a method and apparatus for managing vehicle components according to the embodiments, recorded on a computer including the processor 510 executing the program or the instruction, stored in the memory 530 or the storage device 560.

In some embodiments, at least some components or functions of a method and apparatus for managing vehicle components according to the embodiments may be implemented by using hardware or circuit of the computing device 50, or may be implemented as separate hardware or circuit that may be electrically connected to the computing device 50.

In some embodiments, one or more non-transitory computer-readable media including an instruction executable by the computing device 50 may be provided, and the instruction may cause the computing device 50 to perform the operation, when executed by one or more processors of the computing device 50. Here, the operation may include configurations, functions, steps, or the like described in this specification in connection with a method and apparatus for managing vehicle components according to embodiments.

According to an embodiment, settings and management of the vehicle component having position dependency can be automated, so that the same component having position dependency can be effectively managed, and the position can be identified and controlled in an automated method.

While this disclosure has been described in connection with example embodiments, it should be understood that the present disclosure is not limited to the described embodiments. Rather, the present disclosure is intended to cover various modifications and equivalent arrangements included within the spirit and scope of the appended claims.

What is claimed is:

1. A method for managing a plurality of vehicle components installed at different positions in a vehicle in which a plurality of positioning anchors are provided, the method comprising:
detecting, by a processor, installation positions of the plurality of vehicle components using the plurality of positioning anchors;
receiving, by the processor, attribute data of the plurality of vehicle components through the plurality of positioning anchors;
registering, by the processor, information on a new vehicle component, the information including at least one of whether the new vehicle component has been installed, an installation position of the new vehicle component, or one or more attributes of the new vehicle component, obtained from the attribute data, in a vehicle component database; and
providing, by the processor, a vehicle component management application service based on information on the vehicle component registered in the vehicle component database.

2. The method of claim 1, wherein the attribute data includes at least one of a Bluetooth MAC address, a name, production information, or position information on the installation position, for the new vehicle component.

3. The method of claim 1, wherein the positioning anchors include positioning anchors supporting ultra-wideband (UWB) and Bluetooth Low Energy (BLE).

4. The method of claim 1, wherein the plurality of vehicle components include at least one of a tire, a camera, an ultrasonic wave sensor, or a zone controller.

5. The method of claim 1, further comprising transmitting, by the processor, a predetermined value to the new vehicle component registered in the vehicle component database through a protocol enabling communication with the new vehicle component.

6. The method of claim 1, further comprising updating, by the processor, the installation positions of the plurality of vehicle components by using the plurality of positioning anchors, according to a preset cycle.

7. The method of claim 1, further comprising updating, by the processor, attribute data of the plurality of vehicle components through the plurality of positioning anchors, according to a preset cycle.

8. The method of claim 1, further comprising providing, by the processor, the attribute data to another controller associated with the vehicle.

9. The method of claim 1, further comprising:
determining, by the processor, whether identification information of the new vehicle component that is newly detected is the same as identification information of a vehicle component that was previously detected in relation to a same installation position; and
determining, by the processor, that a replacement of the vehicle component has occurred, based on determining that the identification information of the new vehicle component that is newly detected is not the same as the identification information of the vehicle component that was previously detected in relation to the same installation position.

10. The method of claim 1, wherein providing the vehicle component management application service includes:
transmitting the information on the new vehicle component registered in the vehicle component database to a user terminal in which an application for managing the vehicle is executed;
providing an application service comprising providing status information; and
providing management function with respect to the new vehicle component through the user terminal.

11. An apparatus for managing a plurality of vehicle components installed at different positions in a vehicle in which a plurality of positioning anchors are provided, the apparatus comprising:
one or more non-transitory computer-readable media storing computer-readable instructions; and
one or more processors configured to execute the computer-readable instructions to:
detect installation positions of the plurality of vehicle components using the plurality of positioning anchors,
receive an attribute data regarding the plurality of vehicle components through the plurality of positioning anchors;
register information on a new vehicle component, the information including at least one of whether the new vehicle component has been installed, an installation position of the new vehicle component, or one or more attributes of the new vehicle component, obtained from the attribute data, in a vehicle component database; and
provide a vehicle component management application service based on information on the vehicle component registered in the vehicle component database.

12. The apparatus of claim 11, wherein the attribute data includes at least one of a Bluetooth MAC address, a name, production information, or position information on the installation position, for the new vehicle component.

13. The apparatus of claim 11, wherein the plurality of positioning anchors includes positioning anchors supporting ultra-wideband (UWB) and Bluetooth Low Energy (BLE).

14. The apparatus of claim 11, wherein the plurality of vehicle components includes at least one of a tire, a camera, an ultrasonic wave sensor, or a zone controller.

15. The apparatus of claim 11, wherein the one or more processors are further configured to execute the computer-readable instructions to transmit a predetermined value to the new vehicle component registered in the vehicle component database using a protocol enabling communication with the new vehicle component.

16. The apparatus of claim 11, wherein the one or more processors are further configured to execute the computer-readable instructions to update installation positions of the plurality of vehicle components using the plurality of positioning anchors, according to a preset cycle.

17. The apparatus of claim 11, wherein the one or more processors are further configured to execute the computer-readable instructions to update attribute data regarding the plurality of vehicle components through the plurality of positioning anchors according to a preset cycle.

18. The apparatus of claim 11, wherein the one or more processors are further configured to provide the attribute data to another controller related to the vehicle.

19. The apparatus of claim 11, wherein the one or more processors are further configured to execute the computer-readable instructions to:
determine whether identification information of the new vehicle component that is newly detected is the same as identification information of a vehicle component that was previously detected in relation to a same installation position; and
determine that a replacement of the vehicle component has occurred, based on determining that the identification information of the new vehicle component that is newly detected is not the same as the identification information of the vehicle component that was previously detected in relation to the same installation position.

20. One or more non-transitory computer-readable media storing computer-executable instructions that, when executed by one or more processors, cause the one or more processors to:
detect installation positions of a plurality of vehicle components using a plurality of positioning anchors;
receive attribute data regarding the plurality of vehicle components through the plurality of positioning anchors;
register information on a new vehicle component, the information including at least one of whether the new vehicle component has been installed, an installation position, or one or more attributes of the new vehicle component, obtained from the attribute data, in a vehicle component database; and
provide a vehicle component management application service based on information on the vehicle component registered in the vehicle component database.
